(19) United States
(12) Patent Application Publication
(10) Pub. No.: US 2001/0026828 A1
(43) Pub. Date: Oct. 4, 2001

(54) Instant thickener

(76) Inventors: Pierre Dupart, Zuerich/Witikon (CH); Osvaldo Geromini, Orbe (CH); Jean-Louis Savoy, Chamblon (CH); Kurt Bloechlinger, Kemptthal (CH)

Correspondence Address: Allan A. Fanucci, WINSTON & STRAWN, 200 Park Avenue, New York, NY, 10166, US

(21) Appl. No.: 09/819,261

(22) Filed: Mar. 28, 2001

(30) Foreign Application Priority Data
Mar. 31, 2000 (EP) 00106878.2

(51) Int. Cl. A23L 1/05

(52) U.S. Cl. 426/578; 426/549

(57) ABSTRACT

A cooked-extruded instant thickener and a process for making the same by extrusion cooking. This thickener is made of flour, starch, water, fat, a carbonate and at least one emulsifier, in which 40 to 80% of the starch granules have lost their crystalline structure while preserving their integrity. Such an instant product makes it possible to preserve up to 80% of the potential viscosity of the starting ingredients and to avoid post-thickening during cooling of the reconstituted product.

### TECHNICAL FIELD

The present invention relates to a binding/thickening agent which can be easily dispersed in hot water and which enters into the composition of food products of the type including instant dehydrated prepared meals, soups, juices or sauces. The present invention also relates to a process for the manufacture of such a thickening agent.

### BACKGROUND

Floury and/or starchy products of the wheat flour, corn flour or potato starch type are conventionally used and known in cooking to bind and thicken sauces or soups. Such products are added to a liquid which is flavored to a greater or lesser degree, optionally with added fat, and the whole is cooked and homogenized for a period, at a temperature and with stirring which are sufficient to bring about the swelling and gelatinization of the starch. These products are not instantly dispersible in hot water and require this theromechanical treatment for a sufficiently long period to eliminate lumps. Moreover, these floury ingredients used as thickener have the drawback, in spite of the heating, of giving the finished product a “raw flour” taste.

To overcome these problems and to obtain an easily dispersible product, various processes for the extrusion cooking of flour have been developed.

French patent application 2,614,765 describes a process for the manufacture of a mix for a roux by extrusion cooking. Indeed, a conventional roux is too viscous to be correctly homogenized in cooking-pot-type containers. This document describes the manufacture of a mixture for roux in a twin-screw extruder. This process therefore consists in extruding and heating a mixture of fat and of floury products in a twin-screw extruder at a temperature of from 60° C. to 220° C. for 25 seconds to 25 minutes. It is specified that the quantity of fat is not less than 8%, and is preferably between 15 and 50%. The extrusion is carried out without added water. The maximum pressure applied during the kneading-heating is on the order of 50 bar.

French patent application 2,268,473 describes a product which is expanded to a greater or lesser degree, and which is manufactured by extrusion cooking of potato starch whose maximum degree of hydration is of the order of 40%. The product obtained may be dried and ground so as to be mixed for immediate consumption in the context of human or animal food. In this document, the inventors seek not to preserve but to reduce the viscosity by at least 50% relative to the viscosity developed by the non-cooked-extruded starchy product. This involves dextrinizing, and thereby rendering soluble, a large portion of the starch, so as to reduce its viscosity as much as possible. Moreover, no fat is used.

French patent application 2,233,946 describes a process for cooking-extrusion-expansion of a mixture containing starch, optionally combined with proteins. This document also relates to expanded cooked dietetic products obtained by the process as well as instant flours and semolina obtained by grinding these expanded products. The process consists in applying the extrusion cooking technique in the presence of solely the water of constitution of the mixture. The content of fat in the mixture is limited to 2%, this low content is specified as an essential characteristic. Finally, the temperature inside the extruder increases in steps from the inlet to the outlet nozzle and the speed of rotation of the screw is low, of the order of 28 to less than 100 revolutions/minute.

U.S. Pat. No. 5,145,705 describes a process for the manufacture of a roux base. Such a product contains at least 25% fat. The duration of mixing, optionally carried out in an extruder, is between 2 minutes and 1 hour. All the examples are carried out batchwise in a closed vessel.

European patent application 769,501 describes a process for the manufacture of sheared amylopectin in pulverulent form. This process does not envisage the use of fat. Furthermore, solutions which are reconstituted by rehydrating the powder obtained by this process develop only a low viscosity.

European patent application 384,124 describes the manufacture of an instant binding agent by extrusion cooking. The process is characterized by the absence of addition of water. Moreover, even if the final product contains fat, the latter is not introduced into the extruder but by coating the particles obtained from the extruder.

Extrusion cooking processes require drastic temperature, pressure and shearing conditions. Thus, the extruded product obtained from these processes, after dispersion in hot water, can develop reduced viscosities of only about 40% of the viscosity which obtained with the initial mixture before extrusion. The notion of potential viscosity can thus be defined: it is the viscosity which the starting mixture (before extrusion cooking) would develop after forced dispersion and conventional cooking in an aqueous medium.

The instantly dispersible thickeners obtained by the extrusion cooking of flour according to the prior art therefore exhibit a collapse in viscosity compared with the native product.

Moreover, products of the conventional instant thickener type are subject to the phenomenon of “post-thickening”, where the viscosity of the mixture obtained by dispersion thickens over time when the product is not kept at a high and constant temperature. This is the typical case for soups or sauces that are reconstituted with water at a temperature of close to 100° C. After reconstitution, these products are typically cooled to a lower temperature for consumption, this cooling generally taking about 1 or 2 minutes. Even a slight cooling causes this phenomenon of “post-thickening”, which is harmful to the organoleptic qualities of the product thus obtained. The product thus reconstituted is no longer creamy, unctuous and velvety, but instead is very thick, dense and heavy.

In view of the above, there is a need for an instantly dispersible thickener which avoids the problems of the prior art, and the present invention satisfies this need.

Thus, there is a need for an instant thickening product that has no raw taste and which develops, after rapid dispersion in hot water and without additional cooking, a viscosity which is as high as possible and which is as close as possible to the potential viscosity of the native product, which viscosity should also be stable over a relatively broad temperature range and time interval. The present invention provides a product and process for making the same which satisfies this need.

### SUMMARY OF THE INVENTION

The present invention relates to a thickening-binding agent which can be easily dispersed in hot water comprising as a percentage by weight: about 60 to 80% of flour, about 20 to 40% of starch, about 5 to 15% of water, up to about 2% of a carbonate compound, about 2 to 6% of fat and about 0.5 to 3% of at least one emulsifier, in which about 40 to 80% of the starch granules have lost their crystalline structure while preserving their integrity.

The present invention also relates to a process for the manufacture of an instant thickener by treating the mixtures disclosed herein in a cooker-extruder at a temperature of between about 80° C. and 180° C., at a pressure of about 50 to 160 bar and for about 10 to 60 seconds. These mixtures include about 20 to 40% of starch, about 2 to 10% of added water, up to about 2% of a carbonate, about 2 to 6% of fat and about 0.5 to 3% of at least one emulsifier. The cooker-extruder comprises at least one device for reversing the flow of material provided in the downstream two thirds of the cooker-extruder and the material is cooled to about 60° C. to 100° C. in the cooker-extruder downstream of the device for reversing the flow of material.

Surprisingly, by virtue of the combination of the extrusion cooking conditions and of the ingredients used, a cooked-extruded thickener is obtained which is capable of developing, after dispersion in hot water, a viscosity on the order of about 70 to 80% of the viscosity developed by cooking the same mixture in an aqueous medium before extrusion cooking, that is to say that up to about 70 to 80% of the potential viscosity is preserved. Moreover, once the product according to the invention has been dispersed in a hot liquid, the viscosity obtained remains relatively constant so that the phenomenon of post-thickening is substantially avoided.

### DETAILED DESCRIPTION OF THE PREFERRED EMBODIMENTS

The flours used in the present invention preferably include wheat flour or corn flour. The starch may be a potato, tapioca, wheat or corn starch, which is in the native form or which has been physically and/or chemically modified. The emulsifier used may be a monoglyceride, a mixture of monoglycerides or a monoglyceride derivative. These emulsifiers can be used alone or in the form of a mixture. A preferred mixture is known as DIMODAN® and is marketed by the company DANISCO. The fat may be an oil or a vegetable or animal fat, used alone or in the form of a mixture. This may include sunflower oil, peanut oil or palm oil which are hydrogenated to a greater or lesser degree. While any carbonate compound can be used, alkali carbonates such as sodium bicarbonate are preferred.

During the extrusion cooking process, the emulsifiers form complexes with amylose. These emulsifiers also play the role of lubricant in the extruder, which reduces the shearing applied to the starch granules. This reduction in mechanical energy makes it possible to limit the destruction of the starch granules and to thereby preserve some of their physical integrity. It has been possible to observe that the use of the emulsifier makes it possible to reduce the pressure both at the level of the extruder nozzle and at the level of the space between the screws; these pressures are reduced by about 40% simply by the addition of the emulsifier.

This reduction in shearing is reflected by the fact that some starch granules are still intact and have thus preserved their integrity after the extrusion cooking process. The product leaving the cooker-extruder has a degree of gelatinization of between about 50 and 80%. Thus, it has been observed that the cooked-extruded mixture containing a majority of intact gelatinized starch granules develops a higher viscosity than a mixture containing predominantly split granules. Indeed, a mixture of intact and swollen granules and damaged swollen granules is obtained and it is this mixture which makes it possible, paradoxically, to obtain a high viscosity.

To carry out the present process for the manufacture of a thickener, a mixture having the composition indicated above may be prepared by intimately mixing the pulverulent ingredients and then adding the fluid or liquid ingredients in the first mixing section of an extruder. The mixture comprises a quantity of added water such that the water content may be between about 15 and 23%.

The cooking of the mixture may be carried out in the heating portions of the extruder in which the mixture may be heated, compressed and sheared so as to form a plastic cooked mass. This cooked mass may be extruded through a die using a single screw or a twin-screw extruder.

To carry out these mixing, blending, cooking, kneading, shearing and extrusion operations, a common food industry cooker-extruder can be used. Preferably, this extruder is a twin-screw extruder. An extruder having a length of between about 800 and 1,500 mm or more may be used, which allows a residence time on the order of about 10 to 60 seconds.

Advantageously, the extrusion cooking operation may be carried out in a cooker-extruder, with a preferred device being a CLEXTRAL® BC 45 type, having a length of 1,200 mm. This device comprises a barrel in which two screws rotating in the same direction and meshing with each other are placed. The barrel is thermostated, which allows heating and/or the cooling of the material being blended. The configuration of the screws is chosen so as to provide the mixture with low shearing and mechanical energy. Thus, the level of mechanical energy provided to the blended-cooked-extruded mixture may be between 0.07 and 0.15 kW/kg of product.

The cooker-extruder generally has 4 to 6 heating zones. In the first zone, the configuration of the screws may be such that a fairly substantial screw pitch is provided for mixing and transporting of the ingredients. In the next two or three zones, the material may be transported, kneaded and blended by virtue of a screw pitch whose value decreases progressively. In these zones, the material may also be cooked, at a temperature of between about 90° C. and 180° C. Finally, in the last zone(s), the temperature may be decreased to about 60° C. to 80° C. Heat regulation along the blending device may be provided by inductive heating devices. The temperature profile from the zone of entry to the outlet generally is in the shape of a bell. Thus, the temperature may increase in the extruder from room temperature to about 150° C. to 180° C. prior to the location of the device for reversing the flow of material, and then may be decreased to about 60° C. to 80° C. between this device and the outlet. Such a temperature in the first zone(s) makes it possible to cook the product and to gelatinize a portion of the starch. Subsequently, the decrease in temperature makes it possible to not further damage the starch granules and to preserve the degree of gelatinization.

In the last zone, the material may be kneaded and forced through a die placed at the end of the screw(s) of the extruder. The die generally includes one or more openings whose diameters may be between about 2 and 5 mm.

The cooked-extruded product on leaving the die has a moisture level which may be approximately between about 10 and 20%. This product may be dried by any appropriate means known to a person skilled in the art, to a moisture level of approximately between about 4 and 11%, and preferably to between about 5 and 7%. The product obtained on leaving the die may be ground to a particle size of between about 0.1 and 3 mm, and preferably to about 0.15 and 1 mm. Depending on the moisture level and the size of the product on leaving the die, drying may be performed after the grinding stage.

The product according to the invention may be covered or coated with fat in order to increase the level of fat in the product by up to about 36%. The fat used may be an animal or vegetable fat which is hydrogenated to a greater or lesser degree. Typical examples include sunflower, peanut or palm oil or tallow. The fat can be applied to the extrudate or to the ground particles.

As noted above, after dispersion in hot or boiling water (i.e., water at a temperature of about 34° C. to 40° C.), the viscosity of the thickener remains relatively constant in that it remains within about ±33% of its original value over time. Preferably, the viscosity remains within about ±25% of its original value. With this feature, post-thickening during cooling of the dispersed thickener is conveniently avoided.

The extruder screw(s) may comprise in particular two parallel shafts rotating in the same direction, over which are fitted and attached one against the other two-lobe devices each having the shape of a section of screw whose thickness may be less than, greater than or equal to the screw pitch. Thus, to form a holding zone, or a zone for reversing the flow of material, it will be possible to use two-lobe devices having a negative pitch or a screw portion having a negative pitch. Such a device will increase the residence time of the mixture as well as the pressure upstream thereof. Any device which can provide a negative effect on the flow of material, that is to say pushing this material in the direction of the inlet, would be suitable.

The pressure inside the cooker-extruder can increase gradually up to a level of the device for reversing the flow of material, where it may be of about 120 to 150 bar. Downstream of this device, the pressure value may decrease and may be between about 60 and 100 bar.

Furthermore, a device for kneading the material may be placed after the flowreversing device(s). Such a positive blending device can thus be placed in the final downstream quarter of the extruder. This device serves to reduce the pressure at the end of the blending, near the extrusion nozzle, and may include a succession of positive two-lobe or single-lobe devices.

It is possible to produce, for the implementation of this process, a preferred mixture comprises from about 50 to 75% by weight of wheat flour, and about 25 to 50% by weight of potato starch. About 0.5 to 2% by weight of an emulsifier or of an emulsifier mixture may be added to this mixture, and it is generally introduced at the inlet of the twin-screw cooker-extruder. This mixture is blended and then about 4 to 8% of water and about 3 to 5% of fat are added thereto. The resulting mixture may be blended and gradually heated inside a twin-screw extruder up to about 140° C. to 150° C. The extruder screws preferably include a system for reversing the flow of material placed in the last two thirds of this extruder. After passing through this device, the material may be cooled to about 50° C. to 80° C. Finally, before the outlet orifice, the screws may include a blending device composed of positive two-lobe devices. The cooked and blended product is finally extruded through a die. A typical die may be a plate with holes having diameters of between about 2 and 4 mm.

The mixing and/or kneading operations may be carried out within a residence time of about 30 to 60 seconds in the extruder or the blending device at a pressure of the order of about 50 to 150 bar, while rotating the screw(s) at a speed of between about 100 and 250 revolutions per minute.

Although the extrusion cooking process uses only a small quantity of water compared with what is known in the prior art, the configuration of the screws as well as the quantities and qualities of the ingredients surprisingly produces a mixture that is partially gelatinized and includes intact granules, swollen granules and split granules in proportions which make it possible to preserve up to about 80% of the potential viscosity of the starting mixture. Moreover, the product reconstituted by the addition of hot or boiling water does not exhibit a raw flour taste or the phenomenon of post-thickening. Limited shearing can be obtained despite the very low content of water by virtue of the addition of fat and emulsifier. The latter are also responsible for the high viscosity obtained after reconstitution and for the low post-thickening observed.

### EXAMPLE

A twin-screw cooker-extruder CLEXTRAL® BC 45 having a length of 1,200 mm and whose length/diameter ratio is 21.6, is used in this example. The speed of rotation of the screws is 220 revolutions/minute. The barrel which the cooker-extruder constitutes is subdivided into six thermostated zones. The cooker-extruder screws are also subdivided into six zones of different pitch and length. Thus, the first four zones, zones for mixing and kneading, have a screw pitch which passes from 50 mm for the first to 33 mm for the second and then 25 mm for the third and fourth. The respective lengths are 200, 200, 200 and 150 mm. Moreover, the zones 2, 3 and 4 are heated to around 140° C. After these cooking zones is a device for reversing the flow of material, consisting of a screw portion 50 mm in length, having a negative pitch, pushing the material in the direction of the inlet zone. Following this flow-reversing device are two thermostated zones at 80° C., 100 and 150 mm in length, in which the screws have a screw pitch of 50 and 33 mm, respectively. The latter two zones surround a blending zone 50 mm in length, consisting of a succession of positive two-lobe devices. Finally, a die is provided at the end of the last zone for shaping.

A mixture comprising 72.3% of wheat flour, 26.2% of potato starch and 1.5% of DIMODAN® is introduced at the inlet of the cooker-extruder. 3.1 kg of water and 2 kg of sunflower oil are added, in the extruder, to 50 kg of the mixture.

The extrusion cooking is carried out at a temperature of about 140° C., at a pressure of about 130 bar, in the middle portion of the cooker-extruder. The terminal portion of the extruder namely the last 300 mm before the die, is cooled to a temperature of the order of 80° C.

The die placed at the end of the extruder consists of a plate comprising 5 holes 2 mm in diameter. The product leaving the die has a temperature of about 90° C. The product thus obtained is ground to a particle size of the order of 0.15 mm and then cooled before packaging. An instant thickener is thus obtained in pulverulent form.

This thickener is used in an amount of 30 g of product, to which 450 ml of boiling water are added. The viscosity developed by this thickener is 480 Brabender units. The uncooked extruded initial mixture, after cooking in an aqueous medium in a saucepan, develops a viscosity of 610 Brabender units. Thus, the instant product according to the invention preserves 78.7% of the potential viscosity of the initial mixture. Moreover, during post-dispersion cooling, the sauce prepared using the product according to the invention exhibits a (post-thickening) increase in viscosity of less than 20%.

A traditional instant product dispersed under the same conditions results in a reconstituted product which has a viscosity of the order of 40% of the potential viscosity of the initial product and furthermore, during cooling, post-thickening manifests itself by an increase in viscosity of the order of 100%.

What is claimed is:

1. A cooked and extruded instant thickener comprising as a percentage by weight: about 60 to 80% of flour, about 20 to 40% of starch, about 5 to 15% of water, about 2 to 6% of fat, about 0 to 2% of a carbonate and about 0.5 to 3% of at least one emulsifier, in which about 40 to 80% of the starch granules have lost their crystalline structure while preserving their integrity.

2. The thickener of claim 1, having a viscosity after dispersion in hot water which remains relatively constant so that post-thickening is substantially avoided.

3. The thickener of claim 1 having a viscosity after dispersion in hot or boiling water which is on the order of about 70 to 80% of the viscosity obtainable by simply cooking the mixture in an aqueous medium.

4. The thickener of claim 1, wherein the flour is wheat flour or corn flour, the starch is a native or modified potato, tapioca, wheat or corn starch, the fat is a vegetable oil or animal fat, the emulsifier is a monoglyceride, a monoglyceride derivative or a mixture thereof, and the carbonate is sodium bicarbonate, and having a moisture level of between about 4 and 11%.

5. The thickener of claim 1 in the form of particles having a size of between about 0.1 and 3 mm.

6. The thickener of claim 5 wherein the particles are coated with a fat in an amount of up to about 36% by weight.

7. A process for the manufacture of an instant thickener by treating in a cooker-extruder at a temperature of between about 80° C. and 180° C., at a pressure of about 50 to 160 bar and at a time of about 30 to 60 seconds, a mixture comprising as a percentage by weight: about 60 to 80% of flour, about 20 to 40% of starch, about 2 to 10% of added water, about 2 to 6% of fat, up to about 2% of a carbonate and about 0.5 to 3% of at least one emulsifier, in which the cooker-extruder comprises at least one device for reversing the flow of material provided in the downstream two-thirds of the cooker-extruder and the material is cooled to about 60° C. to 100° C. in the cooker-extruder downstream of the device for reversing the flow of material.

8. The process of claim 7, which further comprises extruding the cooled mixture through a die to obtain an extrudate and grinding the extrudate to obtain a product particle size of between about 0.1 and 3 mm.

9. The process of claim 7, in which the thickener is dried to a moisture level of about 4 to 11%.

10. The process of claim 7, in which the thickener is covered or coated with fat in an amount of up to about 36% by weight of the product.

11. The process of claim 7, in which the cooker-extruder comprises, in addition, a device for kneading the material positioned downstream of the flow-reversing device.

12. The process of claim 7, wherein the thickener has a viscosity after dispersion in hot or boiling water which is on the order of about 70 to 80% of the viscosity obtainable by simply cooking the mixture in an aqueous medium.

13. The process of claim 7, wherein the thickener has a viscosity after dispersion in hot or boiling water which remains relatively constant so that post-thickening is substantially avoided.

14. The process of claim 7, wherein the flour is wheat flour or corn flour, the starch is a native or modified potato, tapioca, wheat or corn starch, the fat is a vegetable oil or animal fat, the emulsifier is a monoglyceride, or a monoglyceride derivative or a mixture thereof, and the carbonate is sodium bicarbonate.

15. The process of claim 7, wherein the extruder is a twin-screw extruder with the screws rotating at a speed of between about 100 and 250 rpm.
